(19) United States
(12) Patent Application Publication
(10) Pub. No.: US 2013/0176094 A1
(43) Pub. Date: Jul. 11, 2013

(54) ANTENNA ASSEMBLY AND COMMUNICATION DEVICE HAVING SAME

(71) Applicants: Ng Guan Hong, Singapore (SG); Roger Tay, Singapore (SG)

(72) Inventors: Ng Guan Hong, Singapore (SG); Roger Tay, Singapore (SG)

(21) Appl. No.: 13/737,888

(22) Filed: Jan. 9, 2013

(30) Foreign Application Priority Data
Jan. 11, 2012 (CN) 201220011036.6

(51) Int. Cl. H01F 38/14; H01F 3/00

(52) U.S. Cl. CPC H01F 38/14; H01F 3/00
USPC 336/107; 336/208; 336/198

(57) ABSTRACT

An antenna assembly includes a loop-shaped coil and a holder. The holder has a first plate, a second plate, and a core disposed between the first plate and the second plate. The loop-shaped coil includes a main coil entwined around the surface of the core of the holder. The main coil includes a hollow space corresponding to the configuration of the core.

### FIELD OF THE INVENTION

The present disclosure relates to communication technologies, and more specifically to an antenna assembly for a communication device, such as a mobile device having a near field communication (NFC) function.

### DESCRIPTION OF RELATED ART

Near field communication (NFC) traces its roots back to radio-frequency identification (RFID). NFC is a set of short-range wireless technologies, typically requiring a distance of 4 cm or less. NFC operates at 13.56 MHz on ISO/IEC 18000-3 air interface and at rates ranging from 106 kbit/s to 424 kbit/s at a distance between 10 cm and 60 cm, which is much faster than infrared transmission and safer than Bluetooth.

NFC is a set of standards for smartphones and similar devices to establish radio communication with each other by touching them together or bringing them into close proximity, usually no more than a few centimetres. Present and anticipated applications include contactless transactions, data exchange, and simplified setup of more complex communications. Communication is also possible between an NFC device and an unpowered NFC chip, called a “tag”.

NFC devices can be used in contactless payment systems, similar to those currently used in credit cards and electronic ticket smartcards, and allow mobile payment to replace or supplement these systems.

A related NFC device includes an antenna determining the performance of the near-field communication distance as well as the NFC electronic terminal machine. A related antenna is made of planar coils with big size and thickness. The antenna could only be attached to a back cover of a mobile phone. However, with the development of slim-type electronic devices such as mobile phones, the antenna wasted considerable space in the mobile phone, which would limit the configuration of the antenna and increasing the size of the mobile phone.

Therefore, it is desirable to provide a new antenna which can overcome the above-mentioned problems.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows an isometric view of an antenna assembly serving a mobile phone, in accordance with an exemplary embodiment of the present disclosure;

FIG. 2 shows an isometric view of the antenna assembly;

FIG. 3 shows an isometric and exploded view of the antenna assembly.

### DETAILED DESCRIPTION OF THE EMBODIMENT

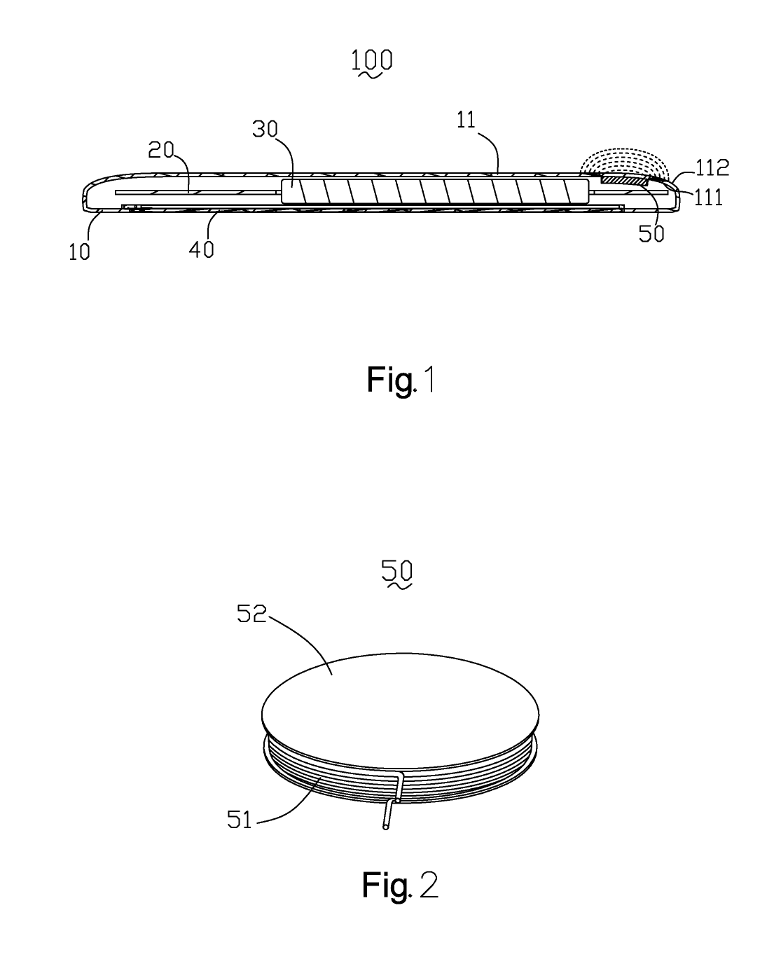

Referring to FIG. 1, a communication device such as a mobile phone 100 comprises a case 10, a circuit board 20, a battery 30, a display screen 40, and an antenna 50. In this embodiment, the case 10 is configured to be a cuboid, and includes various required mechanical and electrical components of the mobile phone 100 installed therein. The display screen 40 covers the case 10 for forming a closed space. Accordingly, the circuit board 20, the battery 30, and the antenna 50 are accommodated in the closed space. The case 10 further includes a rear cover 11. The rear cover 11 is a rectangular plate, and includes an inner surface 111 and an outer surface 112 opposite to the inner surface 111. The antenna 50 is disposed on the inner surface 111 of the rear cover 11 to receive and convert electromagnetic waves to electrical signals.

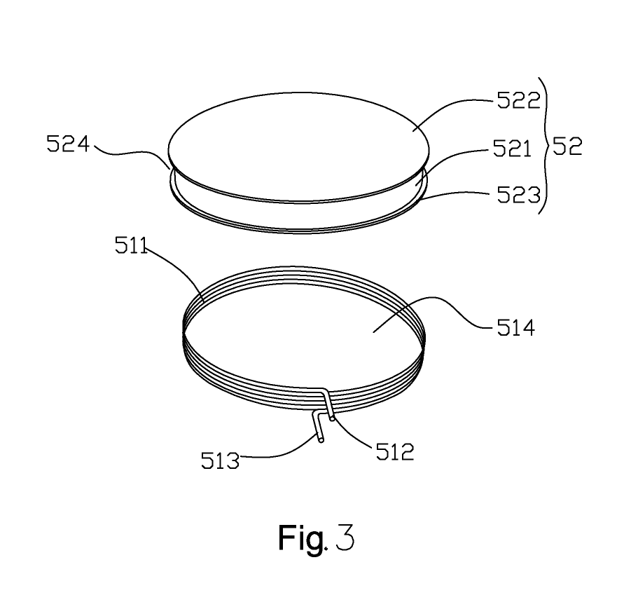

Referring to FIGS. 2-3, the antenna 50 comprises a loop-shaped coil 51 and a holder 52. The loop-shaped coil 51 is wound round the holder 52. In this embodiment, the loop-shaped coil 51 includes a first terminal 512, a second terminal 513, and a main coil 511 extending between the first terminal 512 and the second terminal 513. The main coil 51 forms a hollow space 514 corresponding to the configuration of the holder 52.

In addition, the holder 52 defines a first plate 522 assembled to the inner surface 111 by soldering or adhesive, a core 521 in pancake shape connecting with the first plate 522, and a second plate 523 opposite to the first plate 521 and connecting with the core 521. In other words, the core 521 is located between the first plate 522 and the second plate 523. The holder 52 is at least partially made from ferrite.

In the embodiment, cross sections of the first plate 522 and second plate 523 are circular. Each of the diameters of the first plate 522 and second plate 523 is greater than the maximum diameter of the core 521 for forming a receiving space 524. Then, the main coil 511 is at least partially disposed in the receiving space 524 when the main coil 511 is entwined around the surface of the core 521.

Referring back to FIG. 2, each of the maximum diameters of the first plate 522 and second plate 523 is greater than the outer diameter of the main coil 511 for protecting the main coil 511 from mechanical and environmental damage.

The main coil 511 of the loop-shaped coil 51 may include a single coil, or may include more than one coils, and the rounds, the width of the wire of the coils could be variable. The main coil 511 has a similar outline to the iron core 521. It is simple and cheap to satisfy various needs for the different configuration of the main coil 511 by changing the holder 52.

In summary, the structure of the antenna 50 includes the loop-shaped coil 51 and the holder 52 could save space and make signal be received more stable. In this embodiment, the antenna is used in a mobile phone. In fact, the disclosed antenna may be used in any device with the function of communication. And the antenna may be a NFC antenna, or other antenna with the function of receiving signals.

While the present invention has been described with reference to a specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. An antenna assembly, comprising:
a loop-shaped coil, including a main coil ;
a holder, including a core;
the loop-shaped coil being entwined around the surface of the core of the holder.

2. The antenna assembly as claimed in claim 1, wherein the holder further includes a first plate and a second plate, the iron core is disposed between the first plate and the second plate.

3. The antenna assembly as claimed in claim 2, wherein the loop-shaped coil further includes a first terminal, a second terminal, and the main coil extends between the first terminal and the second terminal, the main coil includes a hollow space corresponding to the configuration of the core.

4. The antenna assembly as claimed in claim 3, wherein each of the diameters of the first plate and second plate is greater than the maximum diameter of the core for forming a receiving space for at least partially receiving the main coil.

5. The antenna assembly as claimed in claim 3, wherein each of the maximum diameters of the first plate and second plate is greater than the outer diameter of the main coil.

6. The antenna assembly as claimed in claim 1, wherein the holder is at least partially made from ferrite.

7. An antenna assembly, comprising:
a loop-shaped coil, including a main coil;
a holder defining a first plate, a second plate, and a core disposed between the first plate and the second plate;
the main coil entwined around the surface of the core of the holder, the main coil having a hollow space corresponding to the configuration of the iron core.

8. The antenna assembly as claimed in claim 7, wherein each of the diameters of the first plate and second plate is greater than the maximum diameter of the core, the core forms a receiving space corporately with the first plate and the second iron plate for at least partially receiving the main coil.

9. The antenna assembly as claimed in claim 7, wherein each of the maximum diameters of the first plate and second plate is greater than the outer diameter of the main coil for protecting the main coil.

10. The antenna assembly as claimed in claim 7, wherein the holder is at leat partially made from ferrite.

11. A communication device, comprising:
a case including a rear cover;
the rear cover having an inner surface and an outer surface opposite to the inner surface;
an antenna assembly attached to the inner surface of the rear cover, the antenna assembly having a loop-shaped coil with a main coil, and a holder;
the holder having a first plate assembling to the inner surface, and an core connecting with the first plate;
the loop-shaped coil being entwined around the surface of the core of the holder.

12. The communication device as claimed in claim 11, wherein the loop-shaped coil further includes a first terminal, a second terminal, and the main coil extends between the first terminal and the second terminal, the main coil forms a hollow space corresponding to the configuration of the core.

13. The communication device as claimed in claim 11, wherein the holder further includes a second plate opposite to the first plate, the core is disposed between the first plate and the second plate.

14. The communication device as claimed in claim 13, wherein each of the diameters of the first plate and second plate is greater than the maximum diameter of the core, the core forms a receiving space corporately with the first plate and the second plate for at least partially receiving the main coil.

15. The communication device as claimed in claim 13, wherein each of the maximum diameters of the first plate and second plate is greater than the outer diameter of the main coil for protecting the main coil.

16. The communication device as claimed in claim 11, wherein the holder is partially made from ferrite.
